(19) United States
(12) Patent Application Publication
(10) Pub. No.: US 2005/0194906 A1
(43) Pub. Date: Sep. 8, 2005

(54) Cold-cathodofluorescent lamp

(75) Inventor: Seiichiro Fujioka, Shinagawa-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/070,087

(22) Filed: Mar. 3, 2005

(30) Foreign Application Priority Data
Mar. 4, 2004 (JP) 2004-061128

(51) Int. Cl. H01J 17/16

(52) U.S. Cl. 313/635; 313/639; 313/621

(57) ABSTRACT

The cold-cathodofluorescent lamp is provided with a glass tube having an internal wall surface to which phosphors are applied and an internal space in which rare gas and mercury are encapsulated and with electrodes installed in both ends of said glass tube, characterized in that the phosphors are applied only over a zone inward relative to the opposite tip surfaces of the two electrodes 7.

### BACKGROUND OF THE INVENTION

1. Field of the Invention

The present invention relates to a cold-cathodofluorescent lamp.

2. Description of the Related Art

A cold-cathodofluorescent lamp is a fluorescent lamp provided with a glass tube having an internal surface where phosphors are applied and rare gas and mercury sealed therein and with electrodes provided in both end portions of the glass tube. Applying a voltage to the electrodes causes emission of electrons from the electrodes, followed by acceleration of the emitted electrons by the high electric field and collision with the atoms of the mercury, causing excitation of these atoms. The mercury atoms which attain to unstable state due to excitation emit excess energy as ultraviolet light (mainly, 253.7 nm) when transiting a stable state. The emitted ultraviolet light in turn excites the phosphors applied over the internal surface of the glass tube causing emission of visible light. The cold-cathodofluorescent lamp is now widely used as a light source for the backlight of a liquid crystal display.

It is necessary to lengthen the life of a light source and the cathodofluorescent lamp is no exception. Although the life of a cathodofluorescent lamp is affected by various factors, the main factor is wasted consumption of the mercury sealed in the glass tube. For this reason, minimizing the waste of the mercury is important to lengthening lamp life. However, when ions hit the surface of an electrode when the cold-cathodofluorescent is turned on, the impact of the bombardment causes spatter of the electrode material (metallic material), which is deposited on the surface of the phosphors near the electrode. The electrode material deposited on the phosphor surface reacts with the mercury in the glass tube, to form amalgam (the alloy of metal and mercury) etc. Consequently, the mercury in the glass tube decreases.

JP 2002-289138 discloses a cold-cathode fluorescent lamp characterized by a short distance between the internal surface of the arc tube (corresponding to said glass tube) and the external surface of the cylindrical electrode. JP 2002-289138 describes that a discharge is generated mainly inside the cylindrical electrodes, thereby sputtering on the external surface of the electrodes is blocked, whereby the sputtering of the electrode material is suppressed. Further, it is described that as a result of suppressing sputtering of electrode material, the formation of amalgam is reduced and the rate of wasted consumption of mercury decreases.

The essence of the technique disclosed in JP 2002-289138 is to suppress the sputtering of the electrode material from the external surface of the cylindrical electrode. Accordingly, the technique is available only when the electrode is tubular or cup-like in shape. For example, it is impossible to apply the technique described in JP 2002-289138 if the electrode is a solid bar or the like, because the discharge takes place only on the external surface of the electrode. In addition, it is necessary in the technique described in JP 2002-289138 to restrict the distance between the internal surface of the arc tube and the external surface of the electrode to a length that is less than or equal to a predetermined value. Consequently, any variation in either the inner diameter of the arc tube or the outer diameter of the electrode involves a variation in the other.

### SUMMARY OF THE INVENTION

It is an object of the present invention to restrain the waste of the mercury in the glass tube in order to lengthen the life of a cold-cathodofluorescent lamp, not by blocking sputtering of the electrode material, but by the novel approach of suppressing the depositing of the spattered electrode material on the phosphors.

The cold-cathodofluorescent lamp according to the present invention is provided with a glass tube having an internal wall surface to which phosphors are applied and an internal space in which rare gas and mercury are encapsulated and with electrodes installed in both ends of the glass tube, characterized in that the phosphors are applied only to a zone axially inward of the glass tube relative to the tip surfaces of the two electrodes that are opposite each other.

The cold-cathodofluorescent lamp of the present invention having the above feature enables substantially blocking the electrode material (metallic material) that is spattered from the electrode by the ion bombardment onto the electrode, from being deposited on the zone where the phosphors are applied, although the electrode material can be deposited on the zone of the internal surface of the glass tube where the phosphors are not applied.

The above and other objects, features and advantages of the present invention will become apparent from the following description with reference to the accompanying drawings which illustrate examples of the present invention.

### BRIEF DESCRIPTION OF THE DRAWINGS

FIG. 1 is a schematic cross-sectional view representing an example of an embodiment of the cold-cathodofluorescent lamp according to the present invention.

FIG. 2 is a schematic enlarged perspective view representing an electrode assembly shown in FIG. 1.

### DESCRIPTION OF THE PREFERRED EMBODIMENT

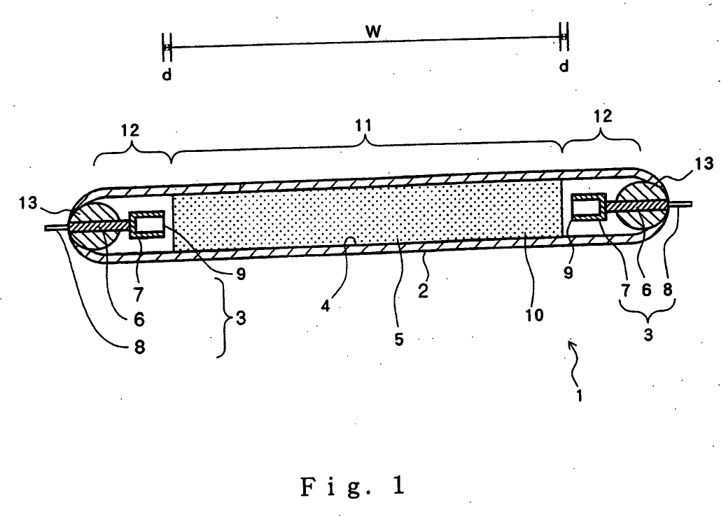

FIG. 1 is a schematic cross-sectional view illustrating a structural overview of the cold-cathodofluorescent lamp of the present embodiment. As shown in FIG. 1, the cold-cathodofluorescent lamp 1 of the present embodiment has elongated glass tube 2 both ends of which are hermetically sealed by electrode assemblys 3. The outer diameter of glass tube 2 is 1.5 to 6.0 mm, preferably 1.5 to 3.0 mm. Glass tube 2 is made of borosilicate glass, flint glass, soda glass, low lead glass, or the like.

Predetermined amounts of mercury and rare gas such as argon, neon, xenon or the like, or mixed gas containing argon, neon, xenon or the like are contained in the internal space 5 of hermetically sealed glass tube 2, and internal pressure is reduced to a pressure of about one-tenth the atmospheric pressure.

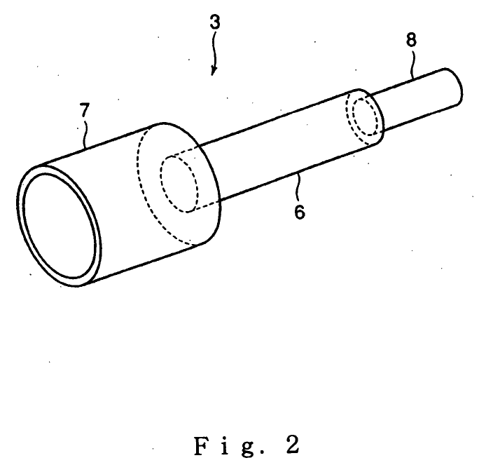

Each electrode assembly 3 which hermetically seal both ends of the glass tube 2 comprise cylindrical solid seal members 6, electrode 7 that is bonded to the one end surface of respective seal member 6 by an electrical or mechanical means, and lead line 8 that is bonded to the other end surface of respective seal member 6 by an electrical or mechanical means, as shown in FIG. 2. Each electrode 7 is made by press-molding a conductive metal plate (for example, a nickel plate) into a hollow cylinder that has a cup-like bottom. The bottom surface of electrode 7 is resistance-welded to one end surface of seal member 6 and one end of lead line 8 is resistance-welded to the other end surface of seal member 6 (the end surface opposite to the end surface to which the electrode 7 is welded). Thus structured electrode assemblys 3 are arranged in glass tube 2 with seal members 6 fixed at the ends of glass tube 2 through bead glasses 13, electrodes 7 arranged in internal space 5 of glass tube 2 and lead lines 8 drawn out of glass tube 2, as shown in FIG. 1. For reference, the shape of electrode 7 is not limited to that shown in the figure and can be solid bar-like or plate-like. Phosphors 10 are applied to a preset zone of internal surface 4 of glass tube 2. Specifically, phosphors 10 are applied only to the zone located nearer to the center of glass tube 2 as viewed in the axial direction of glass tube 2 than to the opposing tip surfaces 9 of the two electrodes 7. In other words, phosphors 10 are not applied to the zones located outside of the tip surfaces 9 of electrodes 7 (the zones nearer to the ends of glass tube 2). Namely, there are zone 11 where phosphors are applied and zones 12 where phosphors are not applied on internal surface 4 of glass tube 2, zone 11 being disposed between two zones 12. In this arrangement, too short a distance between electrodes 7 and phosphors 10 makes it impossible to sufficiently prevent deposition of the electrode material (metallic material) spattered from electrodes 7 during the discharge (lighting of the lamp) on the surface of phosphors 10. Too long a distance between electrode 7 and phosphor 10, on the other hand, leads to a decrease in the effective emission wavelength. From this point of view, it is preferable to set the minimum distance d [mm] from tip surfaces 9 of electrodes 7 to phosphor 10, i.e., the length of zone 11, preferably to be 1.0≦d≦10.0, and further preferably 1.0≦d≦8.0.

In the case where the shape and/or size of glass tube 2 or electrodes 7 is changed, expansion or reduction of width (w) of zone 11 need only be done so that the distance (d) may attain a preset value. When the length of electrodes 7 is lengthened, for example, the shortening of the width (w) of zone 11 axially inward of glass tube 2 makes it possible to set a desired length the distance (d) from tip surfaces 9 of new electrodes 7 to the end of zone 11. Alternatively, when electrodes 7 is replaced with one having a smaller diameter, or when glass tube 2 is changed to a the glass tube having a larger diameter, the distance between the outer periphery of electrodes 7 and internal surface 4 of glass tube 2 increases, resulting in an increase in the above distance (d). In this case, enlarging the width (w) of zone 11 in the axial direction of glass tube 2 yields the desired length of above distance (d). Alternatively, retracting electrodes 7 axially outward of glass tube 2 also yields the desired length of above distance d. The key is that tip surfaces 9 of electrodes 7 and phosphors 10 are spaced apart so that the electrode material spattered from electrodes 7 by the ion bombardment to electrodes 7 will not deposit on the surface of phosphors 10 (the spattered electrode material will not reach the surface of phosphors 10).

Regardless of the area or shape of zone 11, desired phosphors can be selected in accordance with the application and purpose from novel phosphors or known phosphors such as halophosphate phosphors and rare-earth phosphors. Further, it is also feasible to use a phosphor that is synthesized by mixing two or more kinds of phosphors.

The above-described constitution enables substantially blocking the electrode material (metallic material) spattered from the internal and external surfaces of electrode by the ion bombardment onto the electrode, from depositing on the zone where the phosphors is applied, although the electrode material can be deposited on the zone of internal surface 4 of glass tube 2 where the phosphors are not applied. In addition, it is empirically confirmed that the electrode material deposited on the internal surface of the glass tube is more resistant to the formation of amalgam etc. as compared to the electrode material deposited on the phosphors, although the scientific ground for this fact has not been satisfactorily clarified.

Thus, the cold-cathodofluorescent lamp of the present invention enables reducing the consumption (waste) of mercury due to amalgam formation etc, and also enables lengthening the lamp life as compared to conventional cold-cathodofluorescent lamps. The present inventor continuously lighted the cold-cathodofluorescent lamp of the present embodiment and other cold-cathodofluorescent lamps, which have the same structure as the cathodofluorescent lamp of the present embodiment except for the point that phosphors are applied to the entire internal surfaces of the glass tubes, under the same conditions, and compared the lamp lives. The comparison results confirmed that the cathodofluorescent lamp of the present embodiment has a life about 3 to 10 times longer than the life of conventional cathodofluorescent lamps.

While a preferred embodiment of the present invention has been described using specific terms, such description is for illustrative purposes only, and it is to be understood that changes and variations may be made without departing from the spirit or scope of the following claims.

1. A cold-cathodofluorescent lamp provided with a glass tube having an internal surface to which phosphors are applied and an internal space in which rare gas and mercury are encapsulated and with electrodes installed in both ends of said glass tube, said phosphors being applied only to a zone axially inward of said glass tube relative to the tip surfaces of the two electrodes that are opposite each other.

2. A cold-cathodofluorescent lamp according to claim 1, wherein the minimum distance d [mm] from each of said electrodes to said phosphors is 1.0≦d≦10.0.
